(19) United States
(12) Patent Application Publication
(10) Pub. No.: US 2013/0075570 A1
(43) Pub. Date: Mar. 28, 2013

(54) Multi-Suction Disc Device

(71) Applicants: Yuan-Song TSAI, Tainan City (TW); Sheng-Chi LIN, Tainan City (TW)

(72) Inventors: Yuan-Song TSAI, Tainan City (TW); Sheng-Chi LIN, Tainan City (TW)

(21) Appl. No.: 13/241,379

(22) Filed: Sep. 23, 2011

(51) Int. Cl. F16B 47/00

(52) U.S. Cl. 248/363

(57) ABSTRACT

A multi-suction disc device includes at least two suction discs and at least one communicating tube. Each suction disc includes a through-hole extending from an outer face through an inner face thereof. The communicating tube is in communication with the through-hole of each suction disc. The inner face of each suction disc can be sucked and fixed on a supporting surface. When the multi-suction disc device needs to be detached from the supporting surface, simply lift up a portion of one of the suction discs to let external air flow into each suction disc through the communicating tube, allowing all the suction discs to be detached synchronously.

### BACKGROUND OF THE INVENTION

1. Field of the Invention

The present invention relates to a multi-suction disc device and, more particularly, to an apparatus which has a plurality of suction discs for fixing on supporting surfaces.

2. Description of the Related Art

A common suction disc is made of rubber and can be sucked on supporting surfaces such as walls, tables, etc. In use, face an inner face of the suction disc to a supporting surface, and press a central portion of the suction disc against the supporting surface, so that a near-vacuum state is formed between the inner face of the suction disc and the supporting surface. In this way, the suction disc is sucked on the supporting surface.

Suction discs are handy devices used to suck on supporting surfaces. Therefore, many kinds of apparatuses such as hangers include a plurality of suction discs to suck on the supporting surfaces. However, it is troublesome and inconvenient for users to remove the suction discs one by one when the suction discs need to be removed from the supporting surface.

### BRIEF SUMMARY OF THE INVENTION

Thus, an objective of the present invention is to provide a multi-suction disc device to improve the aforementioned problems. The multi-suction disc device includes at least two suction discs. Each of the suction discs can be sucked on supporting surfaces being sucked on such as walls, tables, etc. Further, the suction discs of the multi-suction disc device can be detached synchronously, so that they can easily be removed from the supporting surfaces.

To achieve this and other objectives, a multi-suction disc device of the present invention includes at least two suction discs and at least one communicating tube. Each suction disc includes opposed inner and outer faces, and the inner face of each suction disc is used as a suction face to suck on a supporting surface. Each suction disc further includes an engaging portion formed on the outer face thereof and a through-hole extending from the inner face thereof into the engaging portion thereof. The communicating tube is connected with the suction discs, and the through-holes of the suction discs are in communication with the communicating tube. When the multi-suction disc device needs to be detached from the supporting surface, simply lift up a portion of one of the suction discs to let external air flow into each suction disc through the communicating tube, so that all the suction discs can be detached synchronously.

In a preferred form, each suction disc further includes a central portion and a circumference extending outwardly from the central portion. The engaging portion of each suction disc is protruded from the outer face of the central portion thereof. The inner face of each suction disc is formed in a centrally protruded arc-shape.

In a preferred form, the multi-suction disc device further includes a bendable bar and a plurality of pads extending from two sides of the bar. Each pad is combined with the outer face of one of the suction discs. Further, the at least one communicating tube includes a plurality of communicating tubes, and each communicating tubes is connected with two suction discs. A communicating pipe is disposed on the bar and connected with each of the communicating tubes so that the communicating tubes are in communication with each other.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is a perspective view of a multi-suction disc device in accordance with a first embodiment of the present invention.

FIG. 2 is a cross-sectional view of the multi-suction disc device of FIG. 1.

FIG. 3 shows a perspective view of the multi-suction disc device of FIG. 1 being structured as a hanger.

FIG. 4 is a perspective view of a multi-suction disc device in accordance with a second embodiment of the present invention.

FIG. 5 is a cross-sectional view taken along plane 5-5 in FIG. 4.

FIG. 6 is a partial cross-sectional view of the multi-suction disc device of FIG. 4.

### DETAILED DESCRIPTION OF THE INVENTION

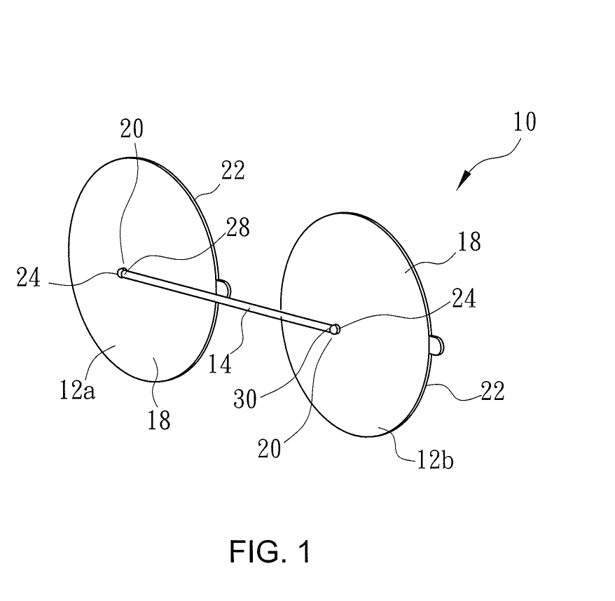

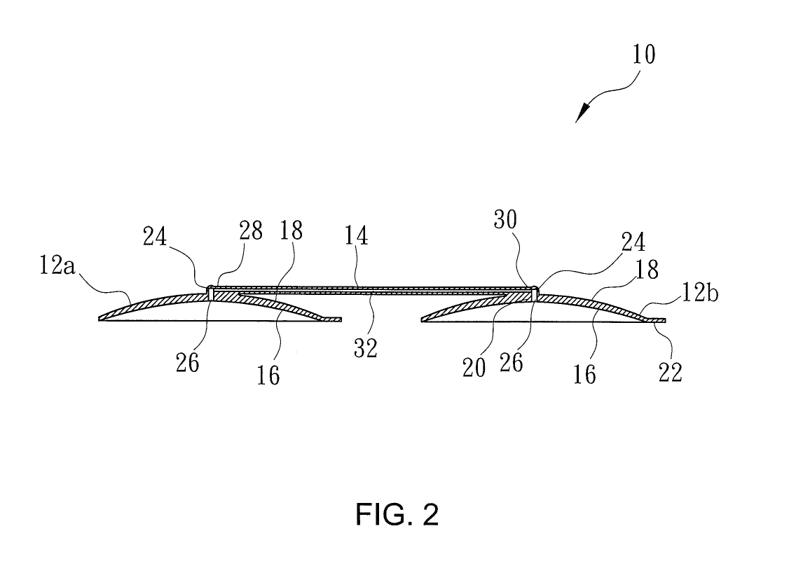

A multi-suction disc device of a first embodiment of the present invention is shown in FIGS. 1 and 2 of the drawings and generally designated 10. The multi-suction disc device 10 includes two spaced suction discs 12a and 12b and a communicating tube 14 connected between the suction discs 12a and 12b. Each of the suction discs 12a and 12b is in round disc shape and made of a hard rubber or hard synthetic resin. Each of the suction discs 12a and 12b includes opposed inner and outer faces 16 and 18. The inner face 16 acts as a suction face used to suck on supporting surfaces such as walls, tables, etc. Each of the suction discs 12a and 12b includes a central portion 20 and a circumference 22 extending outwardly from the central portion 20, such that the inner face 16 is formed in a centrally protruded arc-shape. An engaging portion 24 is protruded from the outer face 18 of the central portion 20 of each of the suction discs 12a and 12b. A through-hole 26 extends from the inner face 16 into the engaging portion 24 of each of the suction discs 12a and 12b.

The communicating tube 14 includes spaced first and second ends 28 and 30. The first end 28 is connected to the engaging portion 24 of the suction disc 12a, and the through-hole 26 of the suction disc 12a is in communication with a tube hole 32 of the communicating tube 14. The second end 30 is connected to the engaging portion 24 of the suction disc 12b, and the through-hole 26 of the suction disc 12b is in communication with the tube hole 32 of the communicating tube 14. Thereby, the through-holes 26 of the two suction discs 12a and 12b are in communication with each other through the communicating tube 14. In this embodiment, the first and second ends 28 and 30 of the communicating tube 14 are integrally combined with the central portions 20 of the suction discs 12a and 12b. It can be appreciated that multi-suction disc device 10 of the present invention can include more than two suction discs, and the communicating tube 14 is in communication with the through-holes 26 of the suction discs.

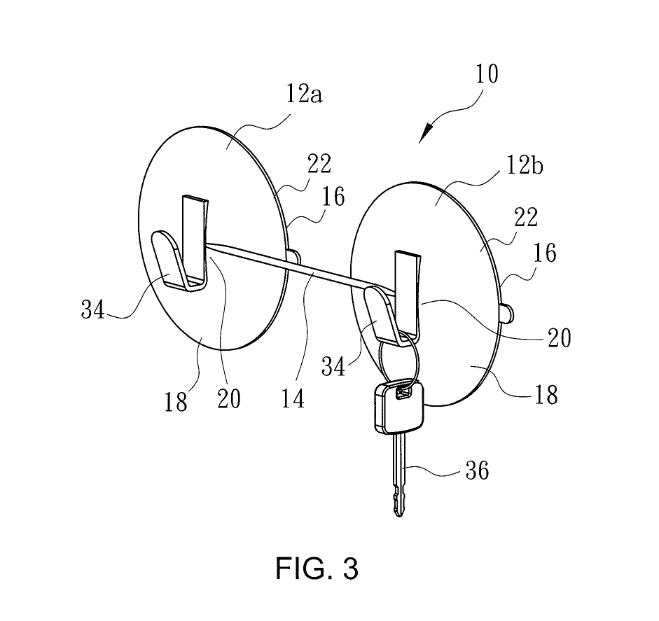

FIG. 3 shows the multi-suction disc device 10 being used as a hanger. A hook 34 is provided on the outer face 18 of each of the suction discs 12a and 12b for hanging an object such as a key 36. In use of suction, face the inner face 16 of each of the suction discs 12a and 12b of the multi-suction disc device 10 to a supporting surface (not shown), then press the central portion 20 of the outer face 18 of each suction disc against the supporting surface, so that a near-vacuum state is formed between the inner face 16 of each suction disc and the supporting surface. Thereby, each of the suction discs 12a and 12b can be sucked and fixed on the supporting surface. On the other hand, when the multi-suction disc device 10 needs to be detached from the supporting surface, simply lift up a portion of the circumference 22 of one of the suction discs (e.g. the suction disc 12a) to let external air flow into another suction disc (e.g. the suction disc 12b) through the through-holes 26 of the suction disc 12a and 12b and the communicating tube 14, so that the suction effect of the suction discs 12a and 12b is eliminated synchronously; therefore, the multi-suction disc device 10 can be easily detached from the supporting surface.

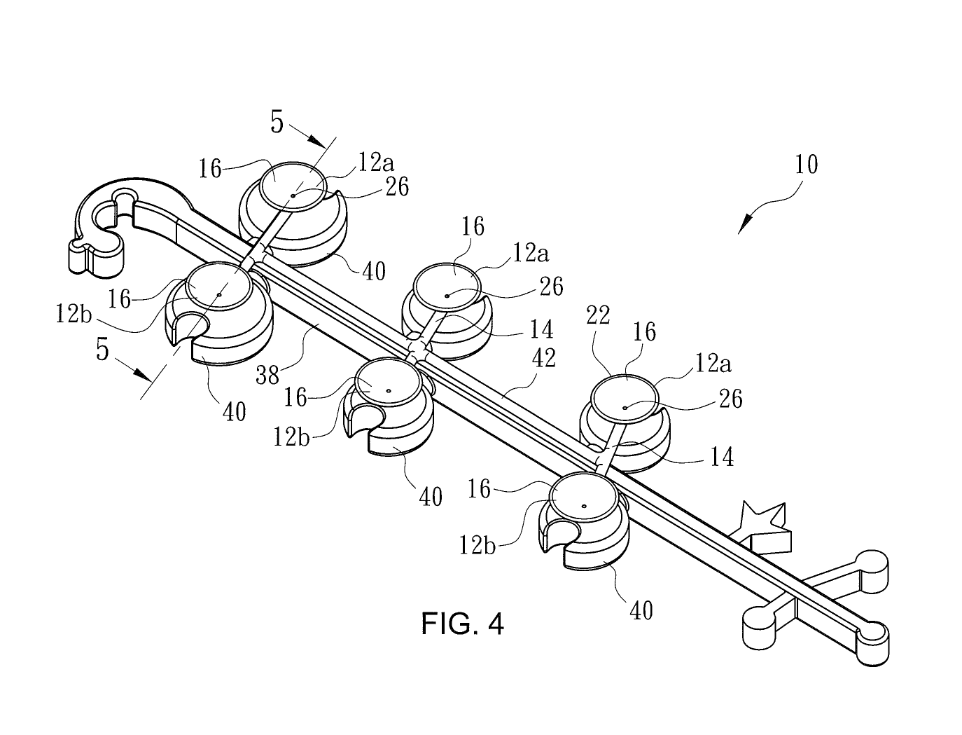

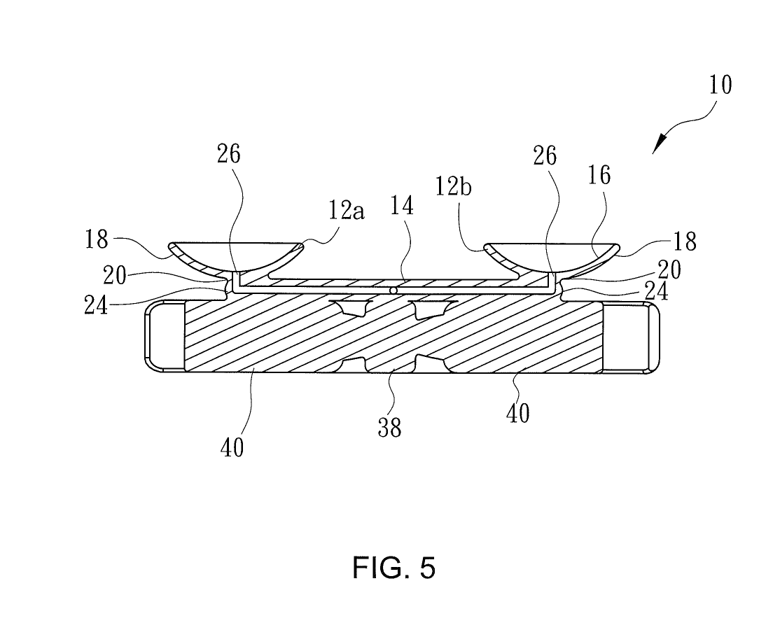

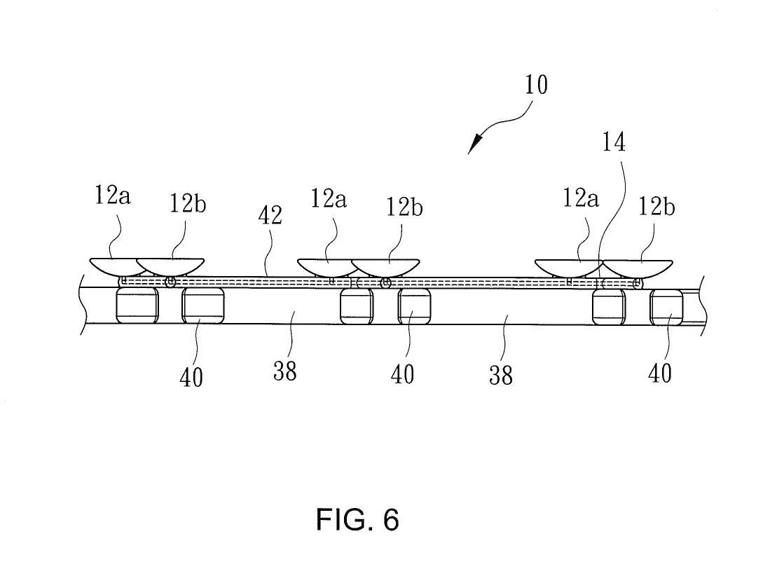

FIGS. 4 through 6 show a multi-suction disc device 10 of a second embodiment of the present invention. In this embodiment, the multi-suction disc device 10 includes three spaced suction discs 12a, three spaced suction discs 12b, and three spaced communicating tubes 14. The same as mentioned previously, each of the communicating tubes 14 is connected between one of the suction discs 12a and one of the suction discs 12b, and through-holes 26 of the two suction discs 12a and 12b connected by each communicating tube 14 are in communication with each other. The multi-suction disc device 10 further includes a bendable bar 38 and a plurality of pads 40 extending from two sides of the bar 38. Each of the pads 40 is combined with the outer face 18 of one of the suction discs, so that the bar 38 and the pads 40 can be available for placing objects when the inner faces 16 of the suction discs 12a and 12b are sucked on a supporting surface. Specifically, users can bend the bar 38 in suitable shapes and suck the suction discs 12a and 12b on the supporting surface, so that the multi-suction disc device 10 can be used as anti-slipping pads or heat insulation pads. Furthermore, a communicating pipe 42 is disposed on the bar 38 and connected with each of the communicating tubes 14, so that the communicating tubes 14 are in communication with each other. Thereby, the through-holes 26 of the suction discs 12a and 12b are in communication with each other. Therefore, When the multi-suction disc device 10 needs to be detached from the supporting surface, simply lift up a portion the circumference 22 of one of the suction discs to let external air to flow into another suction discs through the communicating tubes 14 and the communicating pipe 42, so that the suction effect of all the suction discs is eliminated synchronously. It should be understood that a control valve (not shown) can be disposed on the communicating pipe 42 to control a pipe hole of the communicating pipe 42 to be closed or opened.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A multi-suction disc device, comprising:
at least two suction discs each including opposed inner and outer faces, with the inner face of each of the at least two suction discs used as a suction face to suck on a supporting surface, with each of the at least two suction discs further including an engaging portion formed on the outer face thereof and a through-hole extending from the inner face into the engaging portion thereof; and
at least one communicating tube connected with the at least two suction discs, with the through-holes of the at least two suction discs being in communication with the at least one communicating tube.

2. The multi-suction disc device according to claim 1, with each of the at least two suction discs further including a central portion and a circumference extending outwardly from the central portion, with the engaging portion of each of the at least two suction discs protruded from the outer face of the central portion thereof, and with the inner face of each of the at least two suction discs formed in a centrally protruded arc-shape.

3. The multi-suction disc device according to claim 1, further comprising a bendable bar and a plurality of pads extending from two sides of the bar, and with each of the pads combined with the outer face of one of the at least two suction discs.

4. The multi-suction disc device according to claim 3, with the at least one communicating tube including a plurality of communicating tubes, with each of the plurality of communicating tubes connected with two suction discs, with a communicating pipe disposed on the bar and connected with the communicating tubes so that the communicating tubes are in communication with each other.
